(19) United States
(12) Patent Application Publication
(10) Pub. No.: US 2008/0260290 A1
(43) Pub. Date: Oct. 23, 2008

(54) Changing the Aspect Ratio of Images to be Displayed on a Screen

(75) Inventors: Leo Jan Velthoven, Eindhoven (NL); Michiel Adriaanszoon Klompenhouwer, Eindhoven (NL); Mark Jozef Willem Mertens, Eindhoven (NL); Frederik Jan De Bruijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,563

(22) PCT Filed: Jan. 27, 2005
(86) PCT No.: PCT/IB05/50350

§ 371 Date: Jul. 31, 2006

(30) Foreign Application Priority Data
Feb. 3, 2004 (EP) 04100376.5

(51) Int. Cl. G06K 9/32

(52) U.S. Cl. 382/298

(57) ABSTRACT

The present invention relates to a method, image processing device, image display device including an image processing device and computer program product for changing the size of presentation of an image data stream (X) provided in a image data format. The image processing device (12) comprises at least one image decoding unit (22) selecting at least parts of an image data stream (X_{O}, X_{S}) having a first original field of view to be presented in, and obtaining values of pixel regions from an area larger than the original field of view from the selected image data (X_{S}). The image processing device changes field of view by calculating an image to be displayed conforming to a second field of view based on the obtained data and values. Image data intended to be presented in the first field of view can then be displayed in the second field of view.

The present invention generally relates to the field of changing aspect ratios in relation to coded data images and more particularly to a method, an image processing device, an image display device and a computer program product for changing the size of presentation of an image data stream provided in an image data format.

In the field of presentation of visual information like for instance presentation of televised image data, it is customary to broadcast data to be displayed in a certain format. Here a certain aspect ratio of 4:3, i.e. the relationship between the width and height of the displayed image, is more or less standardized.

However nowadays there are often television screens having different aspect ratios of for instance 16:9, which provides a wider picture. There is even wider aspect movie material, and with future televisions e.g. employing front projectors even this material can become displayable.

In order to be able to show information on the whole of the screen when image data broadcast according to one aspect ratio is presented on a display having another aspect ratio, it is common to provide black bars, cut out information or perform other ways of tampering of the data in order to obtain the new aspect ratio. Such change can be performed through stretching the image horizontally and vertically that leads to loss of information, stretching the image only horizontally that leads to a distortion of the image and so called panoramic stretch, i.e. stretching horizontally with non-uniform zoom factor, which leads to objects placed at the side of an image being more distorted than objects in the center of the image.

One such way of tampering with the data in order to enable the conversion of one aspect ratio to another is described in WO 03/017649. This documents describes the insertion of image information from a previous picture into a present picture. In this way a new aspect ratio is provided without having to stretch the image.

There has furthermore been a movement towards providing different types of digital coding of video data, which format can be used also in transmitting video data. Such formats are among other MPEG2 and MPEG4.

It would in this case be beneficial to use background data that is present in such coding, if a stream including such data is present, to also allow a variation of the aspect ratio, such that an aspect ratio conversion can take place without having to distort the image shown or leave out important information, while at the same time using the whole of the display.

It is therefore an object of the present invention to allow a variation of the field of view for a coded image stream for a display, such that a field of view conversion can take place without having to distort the image shown or leave out important information, while at the same time using the whole of the display.

According to a first aspect of the present invention, this object is achieved by a method of changing the size of presentation of an image data stream provided in an image data format comprising the steps of:

a) obtaining an image data stream coded in a format and having a first original field of view to be presented in,

b) selecting at least parts of the image data stream,

c) obtaining, from selected image data, values of pixel regions from an area larger than the original field of view, and

d) changing the field of view by calculating an image to be displayed conforming to a second field of view based on the obtained data and values, such that image data that is intended to be presented in the first field of view can be displayed in the second field of view.

According to a second aspect of the invention, this object is also achieved by an image processing device for changing the size of presentation of an image data stream provided in an image data format and comprising:

at least one image decoding unit arranged to:
select at least parts of an image data stream having a first original field of view to be presented in, and
obtain values of pixel regions from an area larger than the original field of view from the selected image data,
   wherein the image processing device is arranged to change the field of view by calculating an image to be displayed conforming to a second field of view based on the obtained data and values, such that image data that is intended to be presented in the first field of view can be displayed in a second field of view.

According to a third aspect of the present invention, this object is also achieved by an image display device for changing the size of presentation of an image data stream provided in an image data format and comprising:

a display unit, and

an image processing device comprising:
at least one image decoding unit arranged to:
   select at least parts of an image data stream having a first original field of view to be presented in, and
obtain values of pixel regions from an area larger than the original field of view from the decoded image data,
   wherein the image processing device is arranged to change the field of view based on the obtained data and values, such that image data that is intended to be presented in the first field of view can be displayed in the second field of view.

According to a fourth aspect of the present invention, this object is also achieved by a computer program product to be used on a computer for changing the size of presentation of an image data stream provided in an image data format and comprising computer program code for making the computer execute, when said code is loaded into the computer:

obtain an image data stream having a first original field of view to be presented in, select at least parts of the image data stream,

obtain, from selected image data, values of pixel regions from an area larger than the original field of view, and

change the field of view by calculating an image to be displayed conforming to a second field of view based on the obtained data and values, such that image data that is intended to be presented in the first field of view can be displayed in the second field of view.

Claims 2 and 15 are directed towards providing objects of the image data stream as pixels in different layers, where pixel regions outside the first field of view are provided in at least one layer and combining objects of at least some of the layers of the decoded image data stream including said one layer for providing an output data stream allowing presentation of image data. In this way it is possible to limit the manipulation of the image to be displayed only to those layers, which are affected by the change of field of view.

Claim 3 is directed towards displaying at least some of the image data in the stream on a display with the second field of view.

According to claims 4 and 16 the coded stream is an MPEG-4 image data stream and at least some of the pixel regions that are at least partially outside the original field of view are coded as a sprite. This allows the changing of field of view in a simple manner, since a sprite contains a large amount of information that can be used for changing the field of view.

According to claims 5 and 17 the selected image data information is processed regarding mapping of less satisfactory positions of pixels in the second field of view. This measure allows the change of field of view to be made more efficient if there are not enough pixels in the pixel regions outside the first field of view to be used for obtaining the second field of view or if the relationship between objects in different layers need to be considered in the change of the field of view, like if the geometrical relationship needs to be adjusted, for example if an object would be moving in and out of consecutive images. This can be annoying and distracting the viewer's attention if e.g. part of a person is periodically entering the image from outside, in which case it may be better to always position this person object inside our outside the field of view. Another example is where a person positioned on the edge of a 4:3 image is repositioned on the edge of the enlarged, e.g. 16:9 image.

Claims 6, 7, 8, 9, 10, 18, 19, 20, 21 and 22 are directed towards different ways of processing the selected image data provided outside the first field of view if there are not enough pixels in the pixel regions outside the first field of view to be used for obtaining the second field of view.

Claims 11 and 23 are directed towards processing the selected image data when the relationship between objects in different layers need to be considered in the change of the field of view.

According to claims 12 and 24 the first field of view corresponds to an aspect ratio of 4:3 and the second field of view corresponds to an aspect ratio of 16:9.

According to claims 13 and 25 the values of pixel regions outside the first field of view are provided in at least one different output data stream than the stream including the combined objects. In this way several streams can be combined for enlarging video shown on a display. This also enables the provision of video data to be shown that can be used for different types of screens having different types of aspect ratios.

The present invention has the advantage of allowing a variation of the field of view, for instance the aspect ratio, for a coded image stream for a display, such that a field of view conversion can take place without having to distort the image shown or leave out important information, while at the same time using the whole of the display. This change of field of view is furthermore possible using information already available in the image data stream. This change can therefore be performed without additional complex image processing. The invention is furthermore simple to implement with only slight variations of the decoder associated with the standardized coding format.

The general idea behind the invention is thus to obtain, from a selected image data stream, values of pixel regions from an area larger than the original field of view of the image data stream and change the field of view by calculating an image to be displayed conforming to a second field of view based on the obtained data and values. In this way image data that is intended to be presented with a first aspect ratio can be displayed with a second aspect ratio without distorting the content.

These and other aspects of the invention will be apparent from and elucidated with reference to the embodiments described hereinafter.

The present invention will now be explained in more detail in relation to the enclosed drawings, where

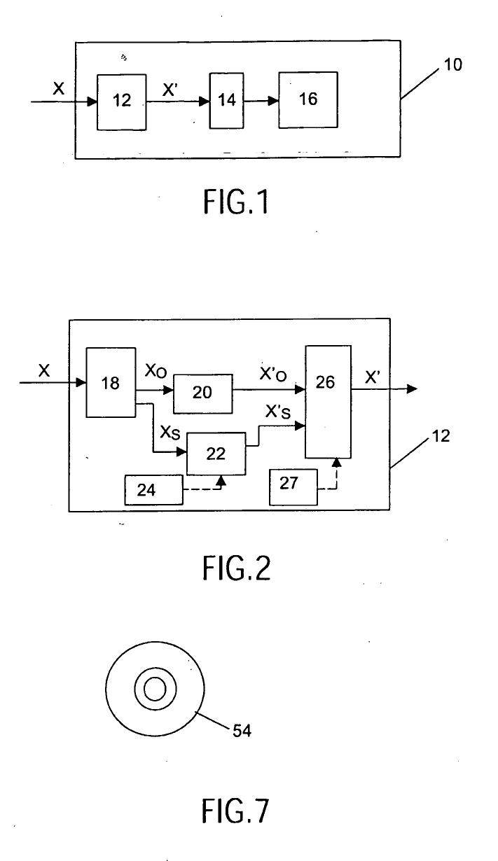

FIG. 1 shows a block schematic of an image display device according to the present invention,

FIG. 2 shows a block schematic of an image processing device according to a first embodiment of the present invention in the image display device of FIG. 1,

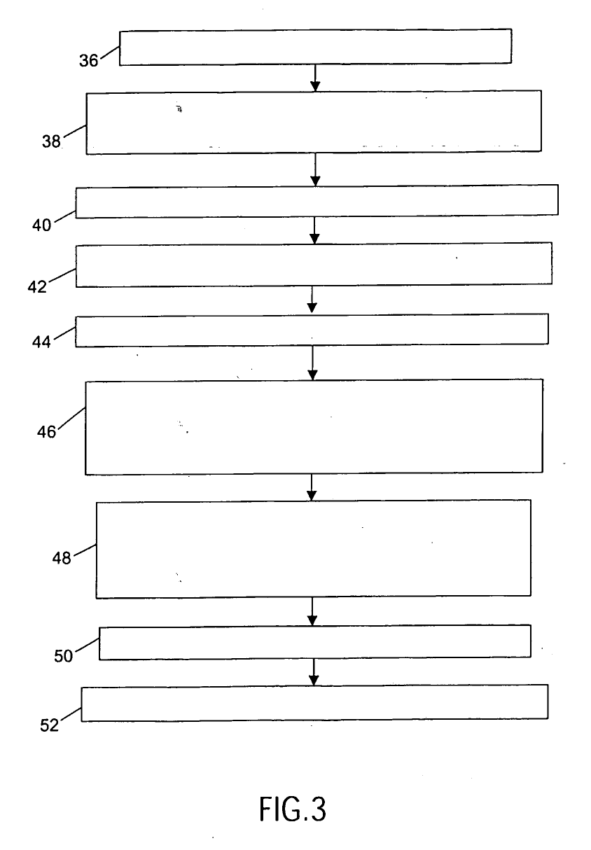

FIG. 3 shows a flow chart of a method of changing aspect ratios according to the present invention,

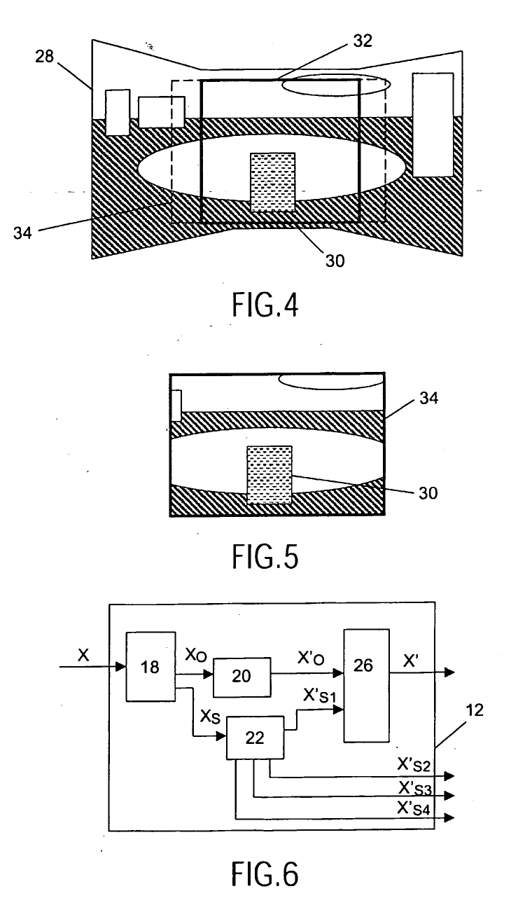

FIG. 4 shows a first image where an object is projected on a background scene in the form of a sprite together with the frame of the stream,

FIG. 5 shows a second image where a larger area has been cut out of the sprite for combination with the object for display with the aspect ratio of the display device,

FIG. 6 shows a block schematic of an image processing device according to a second embodiment of the present invention, and

FIG. 7 schematically shows a CD ROM disc having program code for performing the method according to the present invention.

The present invention generally relates to the field of displaying information on a screen such as on a television screen. Reference will now be made to FIG. 1, which shows a block schematic of an image display device 10, which can be a television device. The image display device 10 includes an image processing device 12, which is connected to a display driving unit 14, which in turn is connected to a display 16. The image processing device 12 in the preferred embodiment receives a video stream X, preferably coded according to the MPEG-4 coding standard, which has been broadcast from a television broadcaster. It should however be realized that the stream could just as well have been retrieved from a local or external storage medium. It should also be realized that MPEG-4 is just an example of a suitably coded stream and that other standards also could be used as long as they have information extending beyond the field of view intended to be presented in. The image processing device 12 processes the received stream in order to provide a video format X′ suitable for submission to a display device. The processed stream X′ is then provided to the driving unit 14 for the display, which converts the information to data suitable for driving the individual pixels of the display 16.

The stream is divided according to frames, where a frame defines the format the stream is to be displayed in at a certain instant in time. The frame format or first original field of view is here normally provided corresponding to an aspect ratio of 4:3. The display 16 does however have another aspect ratio of 16:9, which means that the images to be displayed have to be manipulated in order to be shown on the display 16 and when the whole of the display is to be used. There are a number of methods that exist for manipulating images having a certain aspect ratio for provision to a screen having another aspect ratio, like for instance stretching, providing black bars on the sides of the image etc. With these known schemes it is however hard to use the whole of the screen without influencing the displayed content of the stream in a negative way. A stretching of the image in two directions leads to a loss of information, stretching in one direction, like for instance horizontally, leads to distortion of the objects in the image and a panoramic stretch leads to uneven distortion of the objects. All these effects can be found to be disturbing or annoying for a viewer of the stream.

The present invention is directed towards resolving this.

Before going into more details of the invention a short summary of some of the aspects of MPEG-4 will now be given. Objects to be displayed in a stream are coded into different layers. The coding of objects in a layer here follow close to the coding used in MPEG-2. Thus objects can be coded using motion vectors based on earlier or afterwards sent objects. Normally a layer is provided for each object and one layer is provided for background. The stream is divided according to frames, where each coded layer has some information for an object related to a specific frame. Frames determine what is to be displayed from the different layers at different points in time and for the frames the aspect ratio is also set, which can be seen as a field of view. All frames should then have the same aspect ratio. One of the layers has information that extends far outside the frame and that is a sprite layer. A sprite can then be static information that remains unchanged over a number of frames or dynamic that for instance takes account of motion of the sprite from frame to frame. The sprite includes information about background elements of a scene displayed in a number of frames. The standard allows a great freedom in that layers can be selected for display almost at will. The purpose of the sprite is to increase efficiency of coding of the video stream. The general idea of the invention is to take advantage of the information in the sprite in order to enable a change of aspect ratio for displays such that the entire display area can be used for showing all the information of the video stream without having to distort its content. More information about MPEG-4 can be found in the ISO/IEC standard 14496-2:2001, which is herein incorporated by reference.

The invention will now be described in more detail with reference being made to FIGS. 2 and 3, where FIG. 2 shows a block schematic of an image processing device 12 according to a first embodiment of the invention and FIG. 3 shows a flow chart of a method of changing aspect ratios.

As mentioned earlier the image processing device 12 receives a coded image data stream X having a format according to the MPEG-4 standard, step 36, which is provided to a demultiplexing unit 18. The demultiplexing unit 18 demultiplexes the stream according to the different object layers and frames and sends the separated coded layer information X_{O} and X_{S} to corresponding layer decoders 20, 22, step 38. In FIG. 2 only two layer decoders are shown, where a first 20 is provided for an object layer and a second 22 is provided for a sprite or background layer. It should however be realized that in normal practice several more such decoders and layers can exist. The image data within the object layer can for a given frame furthermore be encoded according to I-, P- and B-frames, while the information in the sprite layer for a frame is based on warping of a whole or part of a static sprite or a video object plane that is coded using prediction based on global motion compensation of previous object planes. In the decoding, decompression from a compressed field of view format, like half D1, to a standard field of view format can take place. Each layer decoding unit 20, 22 thereafter selects and in this example decodes the layer information for its layer for providing objects and background elements that are to be projected. In each frame therefore the first decoder 20 decodes or creates an object X′_{O}, step 40, and the second decoder 22 creates or decodes the background sprite X′_{S}, step 42, which can be seen as obtaining values of pixel regions from a larger area than the first field of view. Pixel regions can here be parts of foreground objects, background objects pixel blocks or single pixels etc. The values of pixel regions comprise at least grey scale values, color and texture model parameters. For the sprite some of the pixel regions thus are at least partially outside the original field of view or aspect ratio. The background sprite and the object are both provided in the frame format to a combining unit 26 for each frame of the video sequence that is to be displayed. A control unit 24 determines a second field of view, which here is the new aspect ratio to be used, step 44, and controls the second decoder 22 to cut out a larger area of the sprite than what the frame is sized according to in order to provide data that can be displayed with the desired aspect ratio of 16:9, i.e. cuts out an area corresponding to the frame and additional areas corresponding to the desired output aspect ratio from the sprite, step 46. The additional cut out areas are then provided together with the frame area of the sprite to the combining unit 26, which combines them X′_{S} with the other object X′_{O}. The cut-out areas of the sprite are then combined with objects obtained through decoding information of other layers, step 48. The combining unit thus calculates an image to be displayed conforming to this second aspect ratio based on cut-out areas of the sprite and the other layers to be displayed. The combining unit 26 then sends these combined images X′ to the display via the display driver, step 50, which displays them, step 52.

If the image to be displayed has less satisfactory positions of the pixels, then the decoded image data is processed regarding mapping of these positions. If for instance the sprite does not have enough information in the cut-out areas, perhaps because some-pixels are missing, the sprite layer is processed by an image extending unit 27 (e.g. an ASIC or software running on a dedicated or general purpose processor) connected to the combining unit 26. This processing can then comprise the standard procedures described earlier, like stretching, estimation of object movement etc. One such procedure, which can be used, is the cutting out areas of previously shown images and using these in later images as described in WO 03/017649, which is herein incorporated by reference. In case there are only relatively small areas missing, this processing could also comprise more advanced texture gap filling methods like a geometrical image transformation of the sprite or the region of the sprite lacking pixel information. The image transformation can then include extrapolation of neighboring pixels, copying of border pixels, etc.

It is furthermore possible to shift some pixels of for instance the object layer in relation to the sprite layer in order to for instance provide an object, which is positioned at an edge of the frame in the first field of view also at the edge of the new field of view. In this way the image can be made to optimally correspond to a particular screen field of view. This is helpful if the object keeps moving in and out of consecutive images, which disturbs the image when displayed with the second aspect ratio. This thus allows the object layer in question to be reproduced in a geometrical position that is a mathematical function of the original geometrical position. This shifting is furthermore not limited to objects provided at an edge of a field of view, but can be applied for any object or any layer.

It should be realized that the control unit 24 can also control, in dependence of selections made for instance by a user, which objects are to be combined and thus also which decoders are to send objects to the combining unit 26. It should also be realized that it might be possible to select between different aspect ratios in the control unit and cut the sprite according to each desired aspect ratio. The control unit might have pre-knowledge of the aspect ratio of the display and control the cutting of the extra area automatically based on this. It is also possible to take account of objects moving out of the frame when performing the selection and cutting of extra areas, in which case the control unit has to have information also from the first decoder 20 in addition to the sprite decoder 22.

In order to further describe the present invention, reference will now be made to FIGS. 4 and 5, where FIG. 4 shows a first image where an object 30 is projected on a background scene in the form of a sprite 28 together with the frame 32 within which the object is normally to be displayed with the aspect ratio of the associated video stream and FIG. 5 shows a second image where a larger area 34 has been cut out of the sprite for combination with the object 30 for display with the aspect ratio of the display device. FIG. 4 also shows the extra cut out area 34 provided because of the changed aspect ratio as a dashed box. The sprite 28 is as was mentioned before much larger than the frame and includes a number of elements provided in the form of squares and ellipses intended to exemplify a number of buildings and a fountain on the ground with the sky as background. The object 30 is here shown as a rectangle for the sake of simplicity. It should be realized that the object as well as the background can have much more complex forms and the object can furthermore change appearance from frame to frame. In order to take account of the new aspect ratio, which in this example was 16:9, areas on the side of the part where the frame 32 is placed in the sprite are cut out, where the whole cut out area including the area of the sprite intended for the original frame is designated with reference numeral 34. This is then combined with the object 30 in the combining unit such that a wider image for the frame is provided that can be shown on the display. The sprite is then continuously used for each following frame for which it applies in order to widen the displayed total image to the desired aspect ratio.

If the scene that is to be shown next is shifted then the above-described method is continued with another sprite relevant to this scene, if one is at hand, to enlarge the area displayed. If no such sprite is at hand the image extending unit is arranged to use the above-mentioned processing to provide the remaining increase in field of view.

A second embodiment of the image processing device according to the present invention is shown in a block schematic in FIG. 6. This device is essentially the same as the one shown in FIG. 2, but there are a few differences. Firstly the control unit has been omitted for better understanding of the invention, secondly the image extending unit has been omitted and thirdly the second decoding unit 22 provides four different streams of decoded sprite data X′_{S1}, X′_{S2}, X′_{S3} and X′_{S4}. The first stream X′_{S1} of decoded sprite data includes the sprite data inside the frame and is sent to the combiner 26 for combining with the object data X′_{O}. The other streams represent cut-out areas of the sprite outside the frame for supply to the display driving unit of FIG. 1. Here the second stream of decoded sprite data X′_{S2} represents a cut-out area to the left of the frame, the third stream of decoded sprite data X′_{S3} represents a cut-out area to the right of the frame and the fourth stream of decoded sprite data X′_{S4} represents a cut-out area on top of or under the frame. In this way several streams are provided that can be combined for enlarging video shown on a display. This also enables the provision of video data to be shown that can be used for different types of screens having different types of aspect ratios. Then the additional streams are selected for display together with the combined stream in order to fit the size of the screen to be used.

The image processing device according to the present invention can be provided in the form of a one or more processors with corresponding program memory containing program code for performing the method according to the present invention. It is also possible to provide this functionality as a hardware unit, for instance as a suitably programmed ASIC circuit. It is furthermore possible to provide some units as processors accessing software code and others as hardware units

The invention can thus also be implemented as a computer program product. A computer program product should be understood to be any physical realization of a collection of commands enabling a processor—generic or special purpose—, after a series of loading steps to get the commands into the processor, to execute any of the characteristic functions of an invention. In particular the computer program product may be realized as data on a carrier such as e.g. a disk or tape, data present in a memory, data traveling over a network connection—wired or wireless—, or program code on paper. Apart from program code, characteristic data required for the program may also be embodied as a computer program product. One example of the computer program product according to the present invention is shown in FIG. 7, which shows a CD ROM disc 54 having program code that will perform the method according to the invention when being loaded into a computer.

With the present invention there are several advantages obtained. The whole of the display is used without distorting any of the objects displayed. The change of aspect ratio is furthermore possible to obtain using information already available in the coded image data stream. This change can therefore be performed without additional complex estimation of scene changes in the image processing device. The invention is furthermore simple to implement with only slight variations of the decoder associated with the standardized coding format MPEG4.

There are several variations that can be made to the present invention. The invention is not limited to the sprite layer but can be applied for any layer having pixel regions extending beyond the field of view. Aspect ratios other than the ones described can for instance also be used. The opposite aspect ratio change is for instance also possible, i.e. from 16:9 to 4:3. The invention is furthermore not limited to a change of aspect ratio, but can be applied on any change of field of view. It is furthermore possible to have more objects and corresponding layers. It is furthermore not necessary to have separate decoders, but the decoding can in many instances be performed in one and the same decoder. The invention is furthermore not limited to MPEG4, but can be applied in other object-based compression applications as long as they have pixel regions that stretch outside the frame. The image extending unit need not be connected to the combiner but can just as well be connected to the relevant layer decoders. It might in fact not be needed at all if the sprite contains enough information that can be used for changing the field of view. The invention is furthermore not limited to television sets, but can be implemented in a video, DVD or any other type of image handling device. It can also be provided for connection to one or more screens, perhaps in the environment of a home network.

1. Method of changing the size of presentation of an image data stream provided in an image data format comprising the steps of:
a) obtaining an image data stream (X) coded in a format and having a first original field of view to be presented in, (step 36),
b) selecting at least parts of the image data stream (X_{O}, X_{S}), (steps 40, 42),
c) obtaining, from selected image data (X_{S}), values of pixel regions from an area (28) larger than the original field of view, (step 46), and
d) changing the field of view by calculating an image to be displayed conforming to a second field of view based on the obtained data and values, (step 48), such that image data (X′) comprises pixel values substantially covering the second field of view.

2. Method according to claim 1, wherein objects of the image data stream are provided as pixels in different layers, where the pixel regions outside the first field of view are provided in at least one layer and the step of changing the field of view comprises combining objects of at least some of the layers of the decoded image data stream including said one layer, (step 48), for providing an output data stream allowing presentation of image data.

3. Method according to claim 1, further comprising the step of
e) displaying at least some of the image data in the stream on a display with the second field of view, (step 52).

4. Method according to claim 1, wherein the coded stream is an MPEG-4 image data stream and at least some of the pixel regions that are at least partially outside the original field of view are coded as a sprite (X_{S}).

5. Method according to claim 1, further comprising the step of
f) processing the selected image data regarding mapping of less satisfactory positions of pixels in the second field of view.

6. Method according to claim 5, wherein the step of processing comprises any of the steps of stretching the image in one direction, stretching the image in one direction with uneven zoom factor, stretching the image in two directions or providing black bars at the sides of the image.

7. Method according to claim 5, wherein the step of processing comprises cutting and pasting older picture material to later picture material if no or insufficient pixel regions outside the original field of view are at hand for provision in the second field of view.

8. Method according to claim 5, wherein the step of processing comprises applying a geometrical image transformation for at least a region of the image outside the original field of view where there are pixels missing for the second field of view.

9. Method according to claim 8, wherein the geometrical image transformation comprises filling the missing pixels using extrapolation of existing pixels.

10. Method according to claim 8, wherein the geometrical image transformation comprises copying border pixels for filling missing pixels.

11. Method according to claim 5, wherein the step of processing comprises shifting at least a region of the pixels of one layer in relation to the pixels of at least one other layer in order to allow the objects of said one layer to be adjusted in relation to objects of said other layer.

12. Method according to claim 1, wherein the first field of view corresponds to an aspect ratio of 4:3 and the second field of view corresponds to an aspect ratio of 16:9.

13. Method according to claim 2, wherein the values of pixel regions outside the first field of view are provided in at least one different output data stream (X′_{S2}, X′_{S3}, X′_{S4}) than the stream (X′) including the combined objects.

14. Image processing device (12) for changing the size of presentation of an image data stream (X) provided in an image data format and comprising:
at least one image decoding unit (22) arranged to:
select at least parts of an image data stream (X_{O}, X_{S}) having a first original field of view to be presented in, and
obtain values of pixel regions from an area (28) larger than the original field of view from the selected image data (X_{S}),
wherein the image processing device is arranged to change the field of view by calculating an image to be displayed conforming to a second field of view based on the obtained data and values, such that the image data (X′) comprises pixel values substantially covering the second field of view.

15. Image processing device according to claim 14, wherein objects of the image data stream are provided as pixels in different layers, where pixel regions outside the first field of view (28) are provided in at least one layer and an image providing unit (26) is arranged to combine objects of at least some of the layers of the decoded image data stream including said one layer for providing an output data stream allowing presentation of image data.

16. Image processing device according to claim 14, wherein the coded stream is an MPEG-4 image data stream and at least some of the pixel regions that are at least partially outside the original field of view are coded as a sprite (X_{S}).

17. Image processing device according to claim 14, further comprising an image extending unit (27) arranged to process the selected image data regarding mapping of less satisfactory positions of pixels in the second field of view.

18. Image processing device according to claim 17, wherein the processing comprises any of the measures stretching the image in one direction, stretching the image in one direction with uneven zoom factor, stretching the image in two directions or providing black bars at the sides of the image.

19. Image processing device according to claim 17, wherein the processing comprises cutting and pasting older picture material to later picture material if no or insufficient pixel regions outside the original field of view is at hand for provision in the second field of view.

20. Image processing device according to claim 17, wherein the processing comprises applying a geometrical image transformation for at least a region of the image outside the original field of view where there are pixels missing for the second field of view.

21. Image processing device according to claim 20, wherein the geometrical image transformation comprises filling the missing pixels using extrapolation of existing pixels.

22. Image processing device according to claim 20, wherein the geometrical image transformation comprises copying border pixels for filling missing pixels.

23. Image processing device according to claim 17, wherein the processing comprises shifting at least a region of the pixels of one layer in relation to the pixels of at least one other layer in order to allow the objects of said one layer to be adjusted in relation to objects of said other layer.

24. Image processing device according to claim 14, wherein the first field of view corresponds to an aspect ratio of 4:3 and the second field of view corresponds to an aspect ratio of 16:9.

25. Image processing device according to claim 14, wherein the values of pixel regions outside the first field of view are provided in at least one different output data stream (X′_{S2}, X′_{S3}, X′_{S4}) than the stream (X′) including the combined objects.

26. Image display device (10) for changing the size of presentation of an image data stream (X) provided in an image data format and comprising:
a display unit (16), and
an image processing device (12) comprising:
at least one image decoding unit (22) arranged to:
select at least parts of an image data stream (X_{O}, X_{S}) having a first original field of view to be presented in, and
obtain values of pixel regions from an area (28) larger than the original field of view from the decoded image data (X_{S}),
wherein the image processing device is arranged to change the field of view based on the obtained data and values, such that image data that is intended to be presented in the first field of view can be displayed in the second field of view.

27. Computer program product (54) to be used on a computer for changing the size of presentation of an image data stream (X) provided in an image data format and comprising computer program code for making the computer execute, when said code is loaded into the computer:
obtain an image data stream (X) having a first original field of view to be presented in, select at least parts of the image data stream (X_{O}, X_{S}),
obtain, from selected image data (X_{S}), values of pixel regions from an area (28) larger than the original field of view, and
change the field of view by calculating an image to be displayed conforming to a second field of view based on the obtained data and values, such that image data (X′) that is intended to be presented in the first field of view can be displayed in the second field of view.
